(19) United States
(12) Patent Application Publication
(10) Pub. No.: US 2014/0205968 A1
(43) Pub. Date: Jul. 24, 2014

(54) Sleeve for Cutting Bur for Dental Cutting Guide

(71) Applicant: DigitalPrep Technologies, Inc., West Valley City, UT (US)

(72) Inventors: Daniel Yonil Jung, Murray, UT (US); Yunoh Jung, Murray, UT (US)

(73) Assignee: DigitalPrep Technologies, Inc., West Valley City, UT (US)

(21) Appl. No.: 14/158,558

(22) Filed: Jan. 17, 2014

Related U.S. Application Data
(60) Provisional application No. 61/754,894, filed on Jan. 21, 2013.
(60) Provisional application No. 61/770,180, filed on Feb. 27, 2013.

(51) Int. Cl. A61C 1/08; A61C 3/02

(52) U.S. Cl. CPC A61C 1/082; A61C 3/02
USPC 433/75; 433/215

(57) ABSTRACT

A dental cutting system for cutting a patient's tooth comprises a cutting guide with a slot to guide a cutting tool. Opposing channels are formed in opposing walls of the slot. A sleeve is slidably disposed in the slot and has an enlarged collar slidably disposed in the opposing channels. The enlarged collar retains the sleeve in the slot with respect to an in-and-out direction and limits the sleeve to movement within and along the slot. The sleeve has a bore removably receiving the cutting tool, with the cutting tool being rotatable in the bore and slidable through the bore in the in-and-out direction, and into and out of the sleeve. The cutting tool has two transverse degrees of freedom, including laterally along the slot, and in and out of the slot and the sleeve.

### PRIORITY CLAIM

Priority is claimed to copending U.S. Provisional Patent Application Ser. Nos. 61/754,894, filed Jan. 21, 2013, and 61/770,180, filed Feb. 27, 2013, which are hereby incorporated herein by reference in their entirety.

### BACKGROUND

1. Field of the Invention

The present invention relates generally to a dental cutting system.

2. Related Art

Various methods have been proposed to cut a patient's tooth. Some methods prepare a user's tooth or adjacent teeth to receive a crown. Some methods provide a cutting guide or template. For example, see U.S. Pat. Nos. 5,725,376 and 4,144,645; US Patent Publication Nos. 2010/0196842; 2010/0192375 and 2012/0270176; PCT Publication No. WO2012/110850; and German Patent Nos. DE 4012327 and DE 4013828. One issue with cutting guides is that the cutting tool can inadvertently cut the guide or template, resulting in an inaccurate guide or template, and inadvertent cutting of the patient's tooth, such as a nerve inside the tooth. In addition, some cutting guides can overly restrict the cutting tool. Furthermore, some cutting systems require custom cutting tools, or cutting tools with non-standard sizes and shapes.

### SUMMARY OF THE INVENTION

It has been recognized that it would be advantageous to develop a system and method to cut a patient's tooth to resist inadvertent cutting of the guide or template, and thus resist medical injury. In addition, it has been recognized that it would be advantageous to develop a system and method to cut a patient's tooth with a guide or template that allows the cutting tool to be withdrawn by the dentist. Furthermore, it has been recognized that it would be advantageous to develop a system and method to cut a patient's tooth that utilized standard cutting tools with standard sizes and shapes already possessed by a dentist.

The invention provides a dental cutting system for cutting a patient's tooth. The system comprises a cutting guide having at least one cavity to match at least a portion of at least one of a patient's teeth. A cutting tool has a shank and a cutting bur configured to cut the patient's tooth. A slot in the cutting guide has a depth extending from an exterior of the cutting guide to the at least one cavity, and receives at least the shank of the cutting tool therein. Opposing channels are formed in opposing walls of the slot, and extend along a length of the slot. A sleeve is slidably disposed in the slot, and slidable along the slot. The sleeve has an enlarged collar slidably disposed in the opposing channels, and retains the sleeve in the slot with respect to an in-and-out direction with respect to the at least one cavity of the cutting guide, and limits the sleeve to movement within and along the slot. The sleeve has a bore extending axially therethrough, and removably receives the cutting tool therein. The shank of the cutting tool is rotatable therein, and the bur of the cutting tool being slidable therethrough in the in-and-out direction, and into and out of the sleeve. The cutting tool is rotatable to cut the tooth, slides laterally in the slot along with the sleeve, and displaces in the in-and-out direction with respect to the at least one cavity of the cutting guide, and into and out of the sleeve.

In addition, the invention provides a dental cutting system for cutting a patient's tooth. The system comprises at least one cutting guide with at least one slot therein, and a cutting tool guided by the slot. Opposing channels are formed in opposing walls of the slot and extend along a length of the slot. A sleeve is slidably disposed in the slot and slidable along the slot. The sleeve has an enlarged collar slidably disposed in the opposing channels, and retains the sleeve in the slot with respect to an in-and-out direction with respect to the at least one cavity of the cutting guide, and limits the sleeve to movement within and along the slot. The sleeve has a bore extending axially therethrough and removably receives the cutting tool therein. The cutting tool is rotatable therein, and slidable therethrough in the in-and-out direction, and into and out of the sleeve. The cutting tool has two transverse degrees of freedom, including laterally along the slot, and in and out of the slot and the sleeve.

Furthermore, the invention provides a method for cutting a patient's tooth, comprising: a) placing a cutting guide on at least one of the patient's teeth with a cavity of the cutting guide matching at least a portion of at least one of the patient's teeth; b) inserting a sleeve into a slot of the cutting guide and an enlarged collar of the sleeve into opposing channels in opposing walls of the slot; c) inserting a bur of a cutting tool into the sleeve with the bur passing through the sleeve and a shank of the cutting tool rotatable in the sleeve; d) displacing the cutting tool along the slot with the sleeve slidable in the slot to cut a portion of the patient's tooth with the bur; and e) selectively retracting and inserting the cutting tool in the sleeve.

In accordance with a more detailed aspect of the invention, the method can further comprise, under the control of one or more computer systems configured with executable instructions: a) obtaining a 3D image of the patient's teeth; b) digitally preparing a tooth to be cut based on the 3D image; c) digitally designing a restoration; d) digitally designing the cutting guide; and e) producing the cutting guide and the restoration.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is an exploded perspective view of a dental cutting system in accordance with an embodiment of the present invention with a cutting tool (namely an occlusal cutting guide for cutting an occlusal side of a tooth) and a cutting guide disposed on a patient's teeth shown in a portion (bottom or top) of a patient's mouth;

FIG. 2 is perspective view of a collar of the dental cutting system of FIG. 1;

FIG. 3 is a cross-sectional side view of the collar of FIG. 2, taken along line 3 of FIG. 2;

FIG. 4a is a side view of the cutting tool of FIG. 1;

FIG. 4b is a schematic side view of the cutting tool of FIG. 4a disposed in the collar of the cutting system of FIG. 1;

FIG. 5a is a side view of another cutting tool of the dental cutting system of FIG. 1;

FIG. 5b is a schematic side view of the cutting tool of FIG. 5a disposed in the color of the cutting system of FIG. 1;

FIG. 6 is a schematic side view of the dental cutting system of FIG. 1, shown at a beginning of a cutting path;

FIG. 7 is a schematic side view of the dental cutting system of FIG. 1, shown moving through the cutting path;

FIG. 8 is an exploded perspective view of the dental cutting system of FIG. 1;

FIG. 9 is a cross-sectional schematic view of the dental cutting system of FIG. 1, taken along line 9 of FIG. 8;

FIG. 10 is a cross-sectional schematic view of the dental cutting system of FIG. 1, taken along line 10 of FIG. 8;

FIG. 11 is an exploded perspective view of the dental cutting system of FIG. 1, shown with a buccal cutting guide for cutting a buccal side of the tooth;

FIG. 12 is an exploded perspective view of the dental cutting system of FIG. 1, shown with a lingual cutting guide for cutting a lingual side of the tooth;

FIG. 13 is a perspective view of another dental cutting guide (namely a buccal and occlusal cutting guide) in accordance with the present invention shown disposed on a patient's teeth;

FIG. 14 is a perspective view of the dental cutting guide of FIG. 13;

FIG. 15 is a perspective view of another dental cutting guide (namely a lingual and occlusal cutting guide) in accordance with the present invention shown disposed on a patient's teeth; and

FIG. 16 is a flow chart of a method of the present invention.

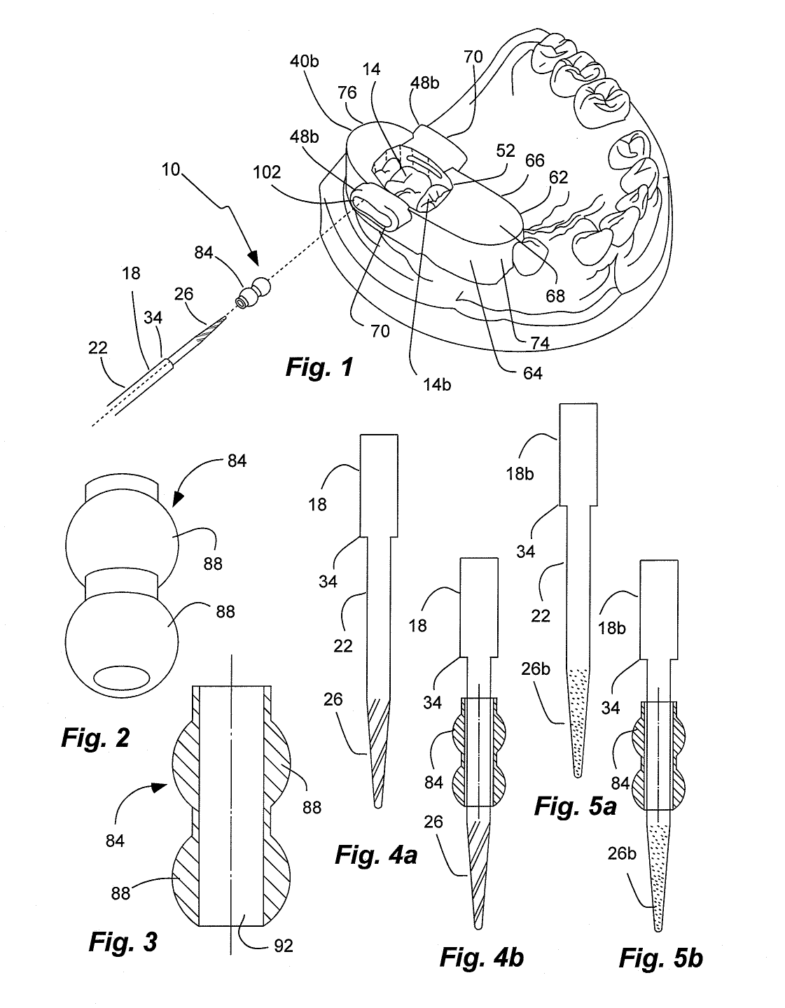

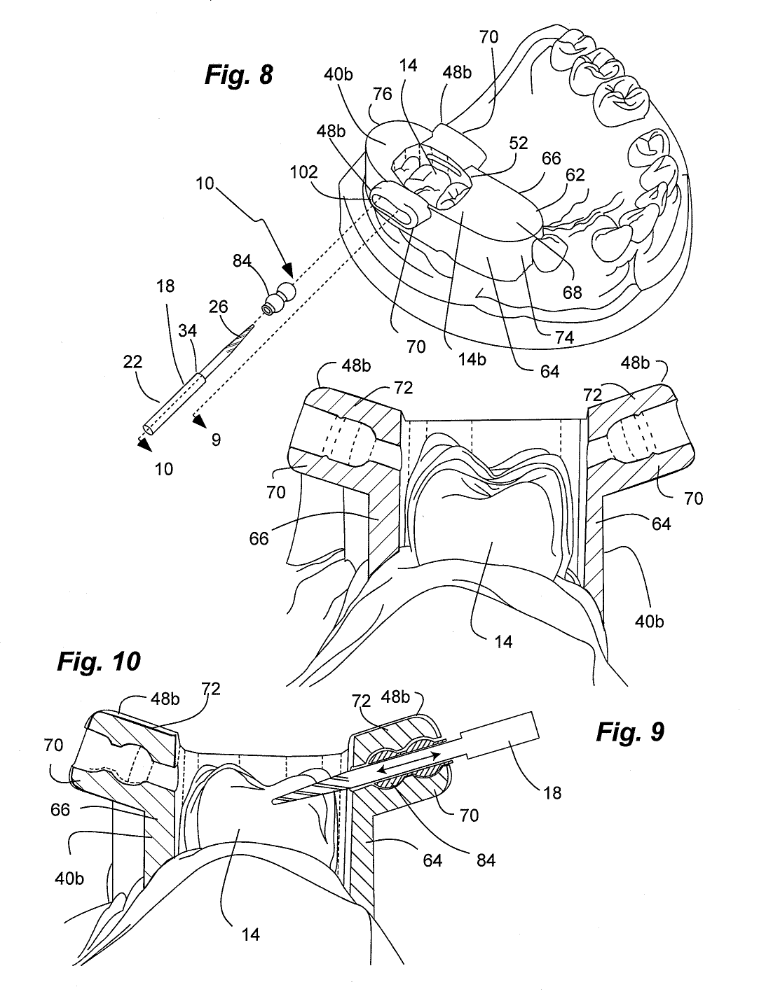

The cutting guides shown in FIGS. 1-16 are shown in an exemplary configuration for cutting a tooth to receive a crown. The cutting guides can be configured to cut one or more teeth to receive other prosthetics or restorations, including by way of example, inlays, veneers, bridges, etc.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

### Definitions

The terms “buccal” and “lingual” are used herein to refer to an outside and a inside, respectively, face or side of a tooth with respect to the user's mouth, and are generally opposite one another, with “buccal” referring to an outside of the tooth generally facing the patient's check or lips, and “lingual” referring to an inside of the tooth generally facing the user's tongue. The terms buccal and lingual are also used herein to refer to directions and locations with respect to the tooth.

The terms “mesial” and “distal” are used herein to refer to a proximal side and a distal side, respectively of the tooth with respect to the user's mouth, and are generally opposite one another, with mesial referring to a front of the user's mouth and distal referring to a back of the user's mouth along a row of teeth.

The term “occlusal” is used herein to refer to a top face of a tooth that faces an opposing tooth when the patient's jaw is closed, and extends between the sides (buccal, lingual, mesial and distal) of the tooth. While the term occlusal generally refers to the posterior teeth, it is used interchangeably with the term “incisal” which generally refers to the anterior teeth.

The term “cutting tool” is used herein to refer to a tool that cuts, and has a cutting surface, such as a bur, and a shank that extends from the cutting surface to be held by a chuck or motor. The cutting surface or bur can have cutting or grinding surfaces or materials. The chuck and/or motor can be part of a dental handpiece that is held by the dentist.

### DESCRIPTION

As illustrated in FIGS. 1-16, a dental cutting system and method are shown in an example implementation in accordance with the invention for cutting a patient's tooth. For example, one or more teeth can be cut to receive a dental prosthesis or restoration, such as a crown, bridge, veneer, inlay, etc. The system and method can include a cutting guide, template, guide, guide body, overlay or the like that has at least one cavity to match at least a portion of at least one of the patient's teeth. For example, the cutting guide can have a cavity that includes cavities to match a series of teeth, or at least a portion thereof, such as the adjacent tooth or teeth adjacent an intermediate tooth or the tooth to be cut (or working tooth). The cutting guide can include one or more slots extending from an exterior of the cutting guide to the cavity or an interior thereof. The slots can be sized, positioned and oriented to receive a cutting tool, and to allow the cutting tool to be moved through the slots in a predetermined cutting pattern, including depth, position and orientation, to cut a predetermined pattern in the patient's tooth or teeth. Thus, the slots in the cutting guide can guide the cutting tool along a path of travel. The cut in the patient's tooth can receive a dental prosthesis (such as a crown, bridge, veneer, inlay, etc.). The slot can include opposing walls, and opposing channels formed in the opposing walls. In another aspect, the slot can include a pair of opposing channels (i.e. first and second opposing pairs of channels) formed in opposing walls of the slot. The cutting guide can be made from plastic, and can be formed by 3D printing, milling, etc. The cutting guide, including the slots and cavity(ies), can be custom made based on a 3D scan of the patient's teeth, and model of the dental prosthesis. Thus, the cutting guide can be placed on the patient's teeth, with the cavities matching and mating, and holding the slots with respect to the teeth, so that the cutting tool cuts the tooth to receive the preformed prosthesis of restoration. In practice, a dentist can scan the patent's teeth in a first visit, or take an impression of the patent's teeth which can be scanned, or from which a model can be made that can be scanned, in a first visit. The scan can be used to create a digitized model of the patient's teeth. The cut(s) to the tooth can be modeled or generated based on the digitized model of the patient's teeth. The cutting tool making the cut(s) can also be modeled. The dental guide(s) can be modeled based on the patent's teeth and the cut(s), and the cutting tool. The dental guide(s) can be formed, such as by 3D printing or milling. The dental prosthesis or restoration can be modeled from the model of the cut tooth and the patient's teeth. The dental prosthesis or restoration can be formed, such as by milling.

As described above, it is possible in some previous systems for the bur of the cutting tool to inadvertently cut the cutting guide, such as being inadvertently inserted into the slot while rotating, thus cutting the slot or guide defining the slot. Such an inadvertent cut in the cutting guide can result in an inaccurate guide or template, and inadvertent cutting of the patient's tooth, such as a nerve inside the tooth. Alternatively, it is possible in some previous systems for the shank of the cutting tool to bear against the wall of the cutting guide at high revolutions per minute, and thus grind away the wall, or create friction that could heat and melt the wall. Cutting or deforming the wall of the cutting guide or slot can cause a deviation of the cutting tool so that the dental prosthetic does not fit or match, or cutting too deep and hurt the patient.

The system and method of the invention includes a sleeve slidably disposed in the slot. The sleeve can have an enlarged collar slidably disposed in the opposing channels. In another aspect, the sleeve can have a pair of enlarged collars slidably disposed in the pair of opposing channels (such as first and second enlarged collars slidable in first and second pairs of opposing channels). The enlarged collar can have a cross-sectional shape that matches a cross-sectional shape of the opposing channels, or an outer profile that matches or mates with the inner profile of the channels. For example, the enlarged collar and the opposing channels, or cross-sections or profiles thereof, can have a round or circular shape. The sleeve can slide along the slot in the cutting guide, while the enlarged collar(s) can slide along in the opposing channel(s). The sleeve has a bore extending therethrough to removably receiving the cutting tool therein. The sleeve can be formed of metal. A bur of the cutting tool can be inserted through the bore and through the collar, while a shank of the cutting tool can be rotatable disposed in the bore of the sleeve. The bur of the cutting tool can be slidable therethrough in and out of the sleeve. Thus, the cutting tool can rotate in the sleeve as the bur rotates to cut the tooth, and the cutting tool can slide laterally in the slot along with the sleeve to displace the bur along the tooth during cutting, and the cutting tool can displace in and out of the sleeve to displace the bur in and out with respect to the tooth during cutting. The sleeve can be restrained in the slot in an in-and-out direction by the enlarged collar(s) on the sleeve. Thus, the sleeve is retained in the slot and in the cutting guide. In addition, the pair of enlarged collars can resist pivoting of the sleeve in the slot, or along the slot, thus maintaining the sleeve upright with respect to the slot. The cutting tool has two transverse degrees of freedom, or directions of motion, including laterally along the slot, and in and out of the slot.

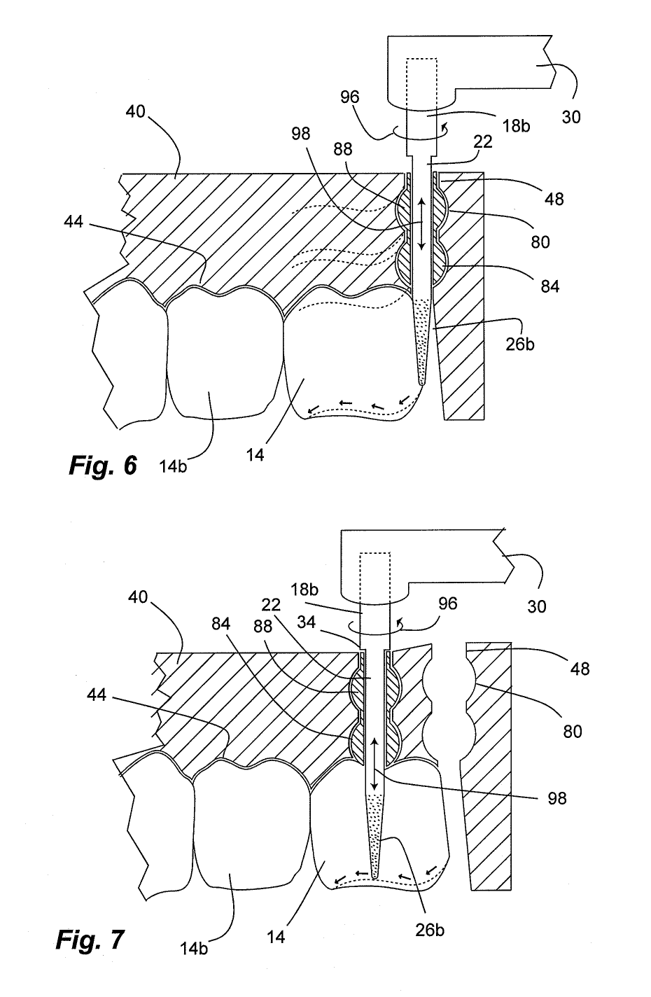

As described above, the dental cutting system 10 for cutting a patient's tooth 14 can comprise at least one cutting guide, with at least one slot therein, and a cutting tool 18 guided by the slot. The cutting tool 18 can have a shank 22 and a cutting bur 26 configured to cut the patient's tooth 14. The shank 22 can be received by a chuck of a dental handpiece 30 (FIGS. 6, 7 and 13). In one aspect, the cutting bur 26 can have cutting edges or surfaces, as shown in FIGS. 4a and 4b. In another aspect, the cutting bur 26b of the cutting tool 18b can have an abrasive or grinding cutting surface, as shown in FIGS. 5a and 5b. In addition, the shank can have an edge or lip 34, as discussed in further detail below. In one aspect, standard cutting tools, with standard shapes and sizes, can be used. Thus, the dentist can utilized tools already acquired without having to obtain custom and costly non-standard cutting tools.

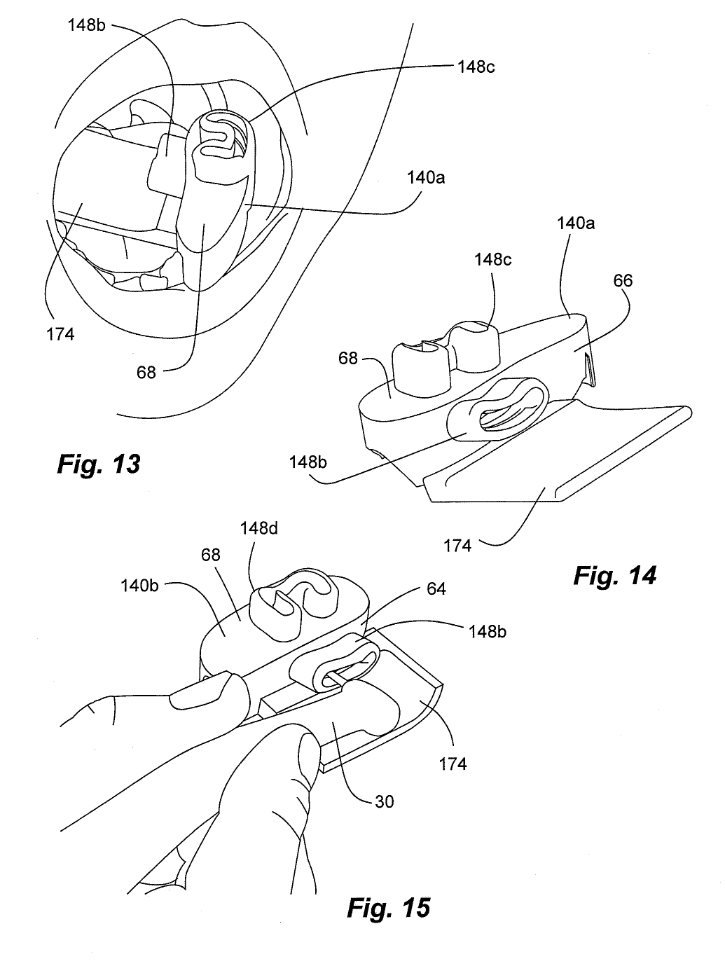

The system 10 can include at least one cutting guide or a plurality of cutting guides. A single cutting guide may be used for cutting a tooth to receive an inlay or a veneer. Two or three (or more) cutting guides may be used for cutting a tooth to receive a crown, or for cutting adjacent teeth to receive a bridge. (Three cutting guides are shown in FIGS. 1, 11 and 12 for cutting a tooth to receive a crown; while two cutting guides are shown in FIGS. 13-15 for cutting a tooth to receive a crown.) Each cutting guide can have one or more slots to guide the cutting tool to make one or more cuts in the tooth. Referring to FIGS. 6 and 7, each cutting guide, indicated generally at 40, can have at least one cavity 44 to match at least a portion of at least one of a patient's teeth 14b. In one aspect, the cavity can be sized and shaped to receive at least a portion of one or more adjacent teeth 14b adjacent to the tooth 14 to be cut. In another aspect, the cavity can be sized and shaped to receive at least a portion of the tooth 14 to be cut. In another aspect, the cavity can be sized and shaped to receive at least a portion of the tooth to be cut and at least a portion of other or adjacent teeth. At least a portion of the cavity or walls thereof can be shaped to match or mate with the patient's teeth 14 and/or 14b. The cutting guide and cavity thereof can be custom made for the patient based on a scan of the patient's teeth or mouth, or impression or model thereof. The cutting guide can have buccal, lingual and occlusal walls abutting or located adjacent to or proximal to the respective buccal, lingual and occlusal surface or side of the tooth or teeth. In addition, the cutting guide may include a mesial and/or distal wall abutting or located adjacent to or proximal to the respective mesial and distal surface or side of the tooth or teeth.

In addition, each cutting guide 40 can have at least one slot, indicated generally at 48, in the cutting guide with a depth extending from an exterior of the cutting guide to the at least one cavity 44 or interior of the cutting guide. The slot 48 can receive at least the shank 22 of the cutting tool 18 therein. Again, the configuration, location and/or orientation of the slot(s) 48 can be custom made for the patient based on the prosthesis or restoration and cut model of the tooth, as described in greater detail below. The slot can define a cutting path or path of travel for the cutting tool, such that moving the cutting tool along the slot properly positions and orients the cutting tool to cut and shape the tooth to form a cut tooth in a predetermined shape and size (as previously modeled) to receive a prosthetic or restoration (also as previously modeled). The cutting guide can comprise plastic and be formed with 3D printing on a 3D printer, or milled or machined, or the like, to create the cutting guide with the slot(s) and cavity therein.

As described above, the system 10 can include at least one cutting guide or a plurality of cutting guides depending on the cut(s) to be made, and the restoration to be performed or installed. In the case of an inlay or a veneer, a single cutting guide may be used. For an inlay, a single cutting guide may be used with a single slot in the occlusal wall of the cutting guide to cut an occlusal surface or side of the tooth to receive the inlay. Similarly, for a veneer, a single cutting guide may be used with a single slot in the occlusal wall of the cutting guide to cut a buccal wall of the tooth or teeth to receive the veneer. In the case of a bridge, multiple cutting guides may be used, each with one or more slots, to cut the teeth to receive the bridge. Similarly, in the case of a crown, multiple cutting guides can be used.

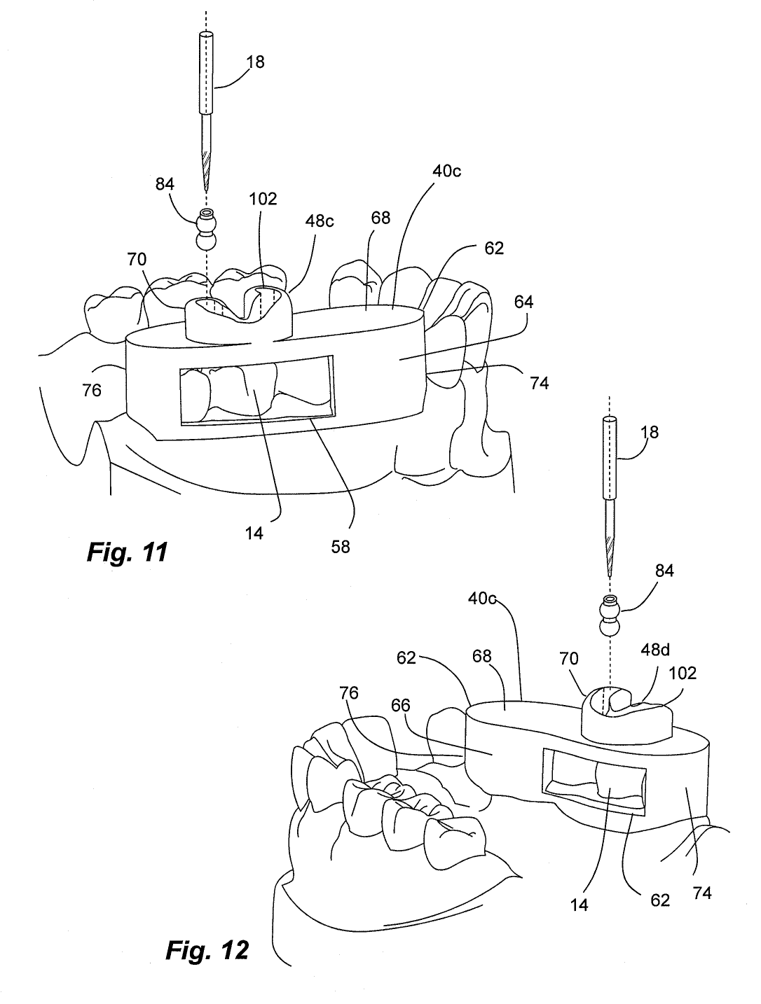

The present invention will be described with respect to a crown with the understanding that such description is applicable to other cases, such as inlays, veneers and bridges. Thus, the plurality of cutting guides can include three cutting guides, namely: an occlusal cutting guide 40b for cutting an occlusal surface or side of the tooth 14, as shown in FIGS. 1 and 8-10; a buccal cutting guide 40c for cutting a buccal surface or side of the tooth 14, as shown in FIG. 11; and a lingual cutting guide 40d for cutting a lingual surface or side of the tooth 14, as shown in FIG. 12.

The occlusal cutting guide 40b, for cutting the occlusal side or surface of the tooth, can have a pair of opposite occlusal slots 48b located laterally on the occlusal cutting guide. One of the occlusal slots can be located on the buccal side or wall of the cutting guide, while the other occlusal slot can be located on the lingual side or wall of the cutting guide, opposite or opposing one another across the cavity. The occlusal slots 48b can be oriented at an incline with an acute angle with respect to a plane of the occlusal side of the tooth, and located to extend approximately midway into the occlusal surface of the tooth, to form a V-shaped cut with an obtuse angle (for purposes of receiving a crown). In addition, the occlusal cutting guide can have an occlusal window 52 disposed in the occlusal wall of the occlusal cutting guide, and located between the pair of occlusal slots 48b. Thus, the tooth 14 can be viewed through the occlusal window 52 during cutting. Similarly, one or more such occulsal cutting guides can be used to cut adjacent but separated teeth to receive a bridge.

The buccal cutting guide 40c, for cutting the buccal side or surface of the tooth 14, can have a buccal slot 48c located in and/or on the occlusal wall of the cutting guide. In addition, the buccal cutting guide 40c can have a buccal window 58 disposed in the buccal wall of the buccal cutting guide and located proximal to the buccal slot and the tooth 14 so that the tooth can be viewed through the window during cutting. Similarly, one or more such buccal cutting guides can be used to cut adjacent but separated teeth to receive a bridge. In addition, such a buccal cutting guide can be used to cut the buccal side or surface of a tooth to receive a veneer. Furthermore, such a cutting guide can also be configured to cut the occlusal surface or side of the tooth to receive an inlay.

The lingual cutting guide 40d, for cutting the lingual side or surface of the tooth 14, can have a lingual slot 48d located in and/or on the occlusal wall of the cutting guide. In addition, the lingual cutting guide can have a lingual window 62 disposed in the lingual wall of the lingual cutting guide and located proximal to the lingual slot and the tooth 14 so that the tooth can be viewed through the window during cutting.

Each cutting guide can comprise a main body 62 configured to engage at least one of a patient's teeth, including a buccal wall 64, a lingual wall 66 and an occlusal wall 68. Each cutting guide can comprise a protrusion 70 extending from the main body 62 and having the slot (48b, 48c, 48d) therein. The protrusion 70 can have a wall 72 surrounding a majority of the slot with a constant cross-sectional shape, as shown in FIGS. 9 and 10. In addition, the cutting guide can include a mesial 74 and/or a distal wall 76 abutting or located adjacent to or proximal to the respective mesial and distal surface or side of the tooth or teeth.

The slots 48 (and 48b, 48c, 48d) have opposing channels 80 formed in opposing walls of the slots, and extending along a length of the slots, as shown in FIGS. 6 and 7. The channels 80 extend laterally into the walls of the slot so that the slot at the channels has a greater diameter than the slot at a location away from the channels. The channels can be located intermediate along the depth of the slot. Thus, the slot can have narrower inner and outer openings, and a wider interior. In one aspect, the slots can have a pair of or dual opposing channels, or first opposing channels, and second opposing channels, as shown. The first and second channels can be separate and discrete with respect to one another, or can overlap one another. In another aspect, the slots can have a single pair of opposing channels. The slots can have a circular or round cross-sectional shape or profile.

A sleeve 84 is disposed in the slot 48 and slidable along the length of the slot. Each slot of each cutting guide can have its own sleeve so that there are multiple sleeves corresponding to multiple slots and multiple cutting guides. Alternatively, a single sleeve can be provided for use in all of the slots and cutting guides. The sleeve can be formed of metal, such as brass. The sleeve can be formed by machining or milling. As described below, the sleeve can have a bore 92 (FIG. 3) extending longitudinally therethrough. The shank 22 of the cutting tool can rotate in the bore 92 of the sleeve 84. Thus, the sleeve can reduce friction and heat formed between the shank and the wall of the slot to resist inadvertent distortion of the slot, and thus inadvertent misguidence of the cutting tool. In addition, the bore 92 of the sleeve 84 can receive the cutting bur 26a or 26b therethrough to resist inadvertent cutting of the walls of the cutting guide, and thus inadvertent misguidance of the cutting tool.

The sleeve 84 has an enlarged collar 88 (FIGS. 2 and 3) disposed in the opposing channels 80 and slidable therein. The enlarged collar 88 of the sleeve 84 retains the sleeve in the slot 48 with respect to an in-and-out direction (represented by arrow 98) with respect to the cavity, and limits the sleeve to movement within and along the slot. In one aspect, the sleeve has a pair of, or dual, enlarged collars, or a first enlarged collar and a second enlarged collar, as shown. The first and second collars can be separate and discrete with respect to one another, or can overlap one another. The first and second enlarged collars in the first and second opposing channels can resist tilting of the sleeve, and thus the cutting tool, in the slot, or along the slot. Thus, the opposing walls of the slot can retain the sleeve laterally in the slot, the pair or collars in the pair of channels can resist tilting of the sleeve in the slot or longitudinally in the slot as the sleeve travels along the slot. In another aspect, the sleeve can have a single collar. The enlarged collar(s) can have a cross-sectional shape or profile that matches a cross-sectional shape or profile of the opposing channel(s). Thus, the enlarged collar(s) 88 of the sleeve 84 can have a circular or round cross-sectional shape or profile. In addition, the enlarged collars(s) can be spherical or partially (truncated) spherical. The collars and the channels can have the same size and shape so that the collars and the channels match or mate to resist tilting of the sleeve in the slot. In one aspect, the enlarged collar(s) can be located intermediate opposite ends of the sleeve, or intermediate along the length of the sleeve. In another aspect, one or both of the enlarged collars can be located at a respective end of the sleeve. The sleeve 84 has a bore 92 extending axially therethrough. The bore 92 of the sleeve removably receives the cutting tool therein. Thus, the bore 92 can have a diameter the same or slightly larger than the cutting tool, or bur or sleeve 22 thereof. The sleeve and collar(s) can be a single, monolithic body formed together. The sleeve can be metallic and formed from metal, such as brass.

The shank 22 of the cutting tool rotates (indicated by arrow 96) in the bore 92 of the sleeve 84 as the cutting tool and bur rotate to cut the tooth. The bur 26a or 26b of the cutting tool 18a or 18b is slidable or insertable through the bore 92 of the sleeve in the in-and-out direction, indicated by arrow 98, and into and out of the sleeve. Thus, the cutting tool 18 can rotate 96 to cut the tooth, slide laterally in the slot 48 along with the sleeve 84, and displace in and out of the bore 92 of the sleeve 84 in the in-and-out direction 98 with respect to the cavity of the cutting guide and the tooth, and into and out of the sleeve. Thus, the cutting tool 18a or 18b has two transverse degrees of freedom, namely longitudinally along the slot (and laterally with respect to the sleeve), and in and out of the slot (in the in-and-out direction 98), and in and out of the sleeve 84.

The cutting guide and/or the slot thereof can have an enlarged opening 102 to receive the sleeve 84, and enlarged collar 88, into the slot. The enlarged opening can be formed in an exterior of the cutting guide and over the slot or at the top or exterior of the slot, and at a location along the slot. The enlarged opening can have the same or greater diameter as the enlarged collar. In one aspect, the enlarged opening can be located at an end of the slot. In another aspect, the enlarged opening can be located intermediate the ends of the slot. In another aspect, the cutting guide can have a lateral opening, shaped as the lateral profile or cross-section of the sleeve, formed in a lateral wall thereof and extending to the slot.

The sleeve 84 can have a length and the slot can have a depth, and/or the opposing channels 80 can be located along the depth of the slot and the enlarged collar(s) 88 can be located along a length of the sleeve, so that an exterior or outer opening or end of the sleeve is visible in an open exterior of the slot, as shown in FIGS. 6, 7 and 10. The sleeve 84 can have the outer opening or edge that extends at least to an outer surface of the cutting guide, again as shown in FIGS. 6, 7 and 10. Thus, the sleeve 84 is visible in the slot so that the dentist can insert the cutting tool into the sleeve.

In one aspect, the sleeve 84 can be inserted into the slot, or enlarged opening 102 thereof, of the cutting guide, prior to receiving the cutting tool. Then the cutting tool 18 can be inserted into the sleeve 84 or bore 92 thereof. Then the handpiece can be actuated and the cutting tool rotated to cut the tooth. In one aspect, the slot can be configured so that the cutting tool is initially located outside the tooth, and the cutting tool can be subsequently slid through the slot (within and along with the sleeve) to cut the tooth in a sweeping motion. The cutting tool or bur can be operated subsequent to full insertion of the bur through the bore of the cutting guide. The sleeve resists the shank from bearing against the cutting guide, and the bur from contacting the cutting guide if withdrawn. In another aspect, the slot can be configured so that the cutting tool is initially located inside the tooth, and the cutting tool can be initially slid into the sleeve and initially cut the tooth in a plunging motion, then the cutting tool can be subsequently slid through the slot (within and along with the sleeve) to cut the tooth in a sweeping motion. Thus, the cutting tool or bur thereof can be operated or rotated while in the bore of the sleeve, to resist the bur cutting the cutting guide. In one aspect, a sleeve can be provided for each slot. Thus, the cutting system can comprise a plurality of slots and a plurality of sleeves, one for each slot. In another aspect, the cutting tool can be inserted into the sleeve 84 or bore thereof, prior to insertion into the slot or enlarged opening thereof. By inserting the cutting tool and the bur thereof into the sleeve, the sleeve resists inadvertent cutting of the cutting guide. At the end of the cutting motion the cutting tool can be withdrawn from the slot of the cutting guide, and from the sleeve, with the sleeve retained in the slot and resisting cutting of the cutting guide in case the cutting tool needs to be reinserted to recut the tooth.

The an edge or lip 34 of the shank 22 of the cutting tool 18 can have a greater diameter than the bur 26, and can abut to the outer edge or opening of the sleeve 84 when fully inserted, as shown in FIG. 7. Thus, the edge or lip 34 of the shank 22 can bear against the sleeve 84 rather than the cutting guide.

In one aspect, a low friction material or fluid can be applied to the interior of the sleeve and/or the shank to reduce friction between the shank and the sleeve, and thus resist the shank from imparting rotation to the sleeve. In another aspect, the enlarged collars of the sleeve can be oblong with a long dimension oriented along the slot and a small dimension oriented against the channel to resist rotation of the sleeve in the slot. In another aspect, a low friction material or fluid can be applied to the interior of the slot and/or an exterior of the sleeve to facilitate sliding of the sleeve in the slot.

The cutting guide can also comprise a window formed through the wall of the cutting guide from an exterior to the cavity, and located adjacent the tooth to be cut, so that the dentist can observe the cutting tool cutting the tooth as the shank moves with the sleeve through the slot. In one aspect, the window can be wider than the slot.

A method for cutting a patient's tooth 14 and utilizing the system 10 described above comprises: placing the cutting guide (40, 40b, 40c, 40d) on at least one of the patient's teeth 14 and 14b with the cavity 44 of the cutting guide matching at least a portion of at least one of the patient's teeth; inserting the sleeve 84 into the slot 48 of the cutting guide (48, 48b, 48c, 48d), and the enlarged collar 88 of the sleeve into the opposing channels 80 in the opposing walls of the slot; inserting the bur 26a or 26b of the cutting tool 18a or 18b into the sleeve 84 with the bur passing through the sleeve, and the shank 22 of the cutting tool rotatable in the sleeve; displacing the cutting tool 18a or 18b along the slot (48, 48b, 48c, 48d) with the sleeve 84 slidable in the slot, and the collar 88 slidable in the channels 80, to displace the bur along the patient's tooth 14 to cut a portion of the patient's tooth with the bur; and selectively retracting and inserting the cutting tool 18a or 18b in the sleeve 84. The cutting guide can be removed and a prosthetic or restoration affixed to the user's cut tooth. Another cutting guide can be subsequently placed on the patent's teeth, and subsequent cuts made. For example, the occlusal cutting guide 40b can be placed on the user's teeth to make occlusal cuts in the occlusal face of the tooth; the occlusal cutting guide can be removed and the lingual cutting guide 40c can be placed on the user's tooth to make a lingual cut in the lingual face of the tooth; and the lingual cutting guide 40c can be removed and the buccal cutting guide 40d can be placed on the user's teeth to make buccal cuts to the buccal face of the tooth. The cutting tool can be withdrawn from the sleeve and the cutting guide while the sleeve remains in the slot of the cutting guide.

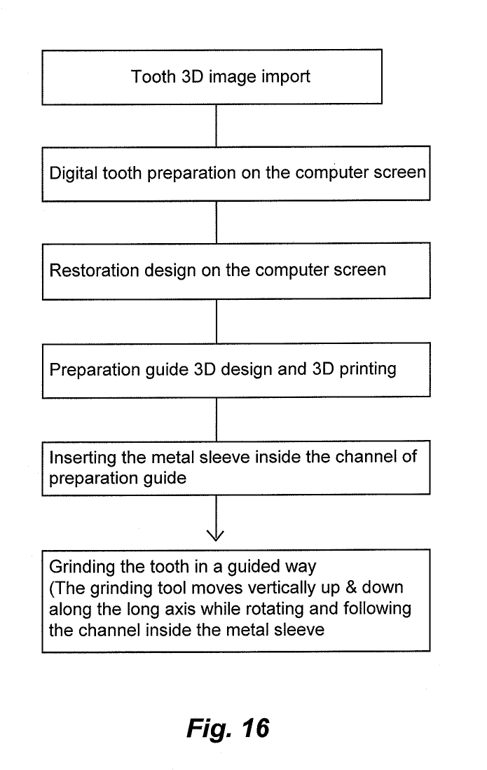

As described above, and with reference to FIG. 16, the method can further comprise: obtaining a 3D image or model of the patient's teeth; digitally preparing a tooth to be cut based on the 3D image; digitally designing a restoration; digitally designing the cutting guide; and producing the cutting guide and the restoration. The 3D image can be obtained from scanning the patient's teeth directly; scanning an impression of the patient's teeth; or scanning a model of the patient's teeth made from the impression. The 3D scan can be or can be used to create a digital model of the patient's teeth. The cuts can be modeled on the digital model of the patient's teeth with a digital model of the cutting tool and/or burr. In addition, a digital model of the cut tooth can be created or prepared. A prosthesis or restoration can be designed digitally using the digital model of the cut tooth, and the digital model of the patient's teeth, to create a digital model of the prosthesis or restoration. In addition, the cutting guide(s) can be designed and modeled using the model of the patient's teeth, the digital model of the tooth to be cut, and the digital model of the cutting tool and/or bur, to create a digital model of the cutting guide. The cutting guide(s) can be produced using 3D printing or milling. The prosthesis can be produced by milling or machining. The system can include one or more computer system with executable instructions to control the above.

Referring to FIGS. 13-15, another dental cutting system is shown that is similar in many respects to that described above, and which description is hereby incorporated herein by reference. The cutting system includes a pair of cutting guides, namely an occlusal/buccal cutting guide 140a and an occlusal/lingual cutting guide 140b. The cutting system and the cutting guides are configured, by way of example, to prepare or cut a tooth to receive a crown. The occlusal/buccal cutting guide 140a includes a pair of transvers slots, including an occlusal slot 148b in a lateral side and lingual wall 66 of the cutting guide to cut the occlusal face of the tooth, and a buccal cutting guide 148c in the occlusal wall 68 of the cutting guide to cut the buccal face of the tooth. The occlusal/lingual cutting guide 140b includes a pair of transvers slots, including an occlusal slot 148b in a lateral side and buccal wall 64 of the cutting guide to cut the occlusal face of the tooth, and a lingual cutting guide 148d in the occlusal wall 68 of the cutting guide to cut the lingual face of the tooth. Thus, two cutting guides can be used to prepare or cut the tooth for a crown, as opposed to three as described above. In addition, the cutting guides 140a and 140b can include a shelf 174 extending from the cutting guide or lateral wall thereof adjacent to the occlusal slots 148b, and extending beyond the slots, to receive a head of the handpiece 30, and/or to separate the patient's tongue from the handpiece and cutting tool. The cutting guides described above can also include a shelf or guard.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A dental cutting system for cutting a patient's tooth, the system comprising:
a) a cutting guide having at least one cavity to match at least a portion of at least one of a patient's teeth;
b) a cutting tool having a shank and a cutting bur configured to cut the patient's tooth;
c) a slot in the cutting guide having a depth extending from an exterior of the cutting guide to the at least one cavity, and receiving at least the shank of the cutting tool therein;
d) opposing channels formed in opposing walls of the slot and extending along a length of the slot;
e) a sleeve slidably disposed in the slot and slidable along the slot;
f) the sleeve having an enlarged collar slidably disposed in the opposing channels and retaining the sleeve in the slot with respect to an in-and-out direction with respect to the at least one cavity of the cutting guide and limiting the sleeve to movement within and along the slot; and
g) the sleeve having a bore extending axially therethrough and removably receiving the cutting tool therein, the shank of the cutting tool being rotatable therein and the bur of the cutting tool being slidable therethrough in the in-and-out direction and into and out of the sleeve such that the cutting tool rotates to cut the tooth, slides laterally in the slot along with the sleeve, and displaces in the in-and-out direction with respect to the at least one cavity of the cutting guide, and into and out of the sleeve.

2. A system in accordance with claim 1, wherein the enlarged collar is located intermediate opposite ends of the sleeve.

3. A system in accordance with claim 1, wherein the enlarged collar has a cross-sectional shape that matches a cross-sectional shape of the opposing channels.

4. A system in accordance with claim 1, wherein the cutting tool has two transverse degrees of freedom, including laterally along the slot, and in and out of the slot and the sleeve.

5. A system in accordance with claim 1, wherein the sleeve has an outer opening that is visible.

6. A system in accordance with claim 1, wherein the sleeve has an outer opening and outer edge that extends at least to an outer surface of the cutting guide.

7. A system in accordance with claim 1, wherein the sleeve has a pair of enlarged collars.

8. A system in accordance with claim 1, wherein the at least one cutting guide includes a main body configured to engage at least one of a patient's teeth including buccal, lingual and occlusal walls; and wherein the at least one cutting guide includes a protrusion extending from the main body and having the slot therein, with the protrusion having a wall surrounding a majority of the slot with a constant cross-sectional shape.

9. A system in accordance with claim 1, wherein the at least one cutting guide is an occlusal cutting guide, and the slot includes a pair of opposite occlusal slots located laterally on the occlusal cutting guide; and wherein the occlusal cutting guide further comprises an occlusal window disposed in an occlusal wall of the occlusal cutting guide and located between the pair of occlusal slots.

10. A system in accordance with claim 1, wherein the at least one cutting guide is a buccal or a lingual cutting guide, and the slot includes a buccal or a lingual slot located on an occlusal wall; and wherein the buccal or lingual cutting guide further comprises a buccal or a lingual window disposed in a buccal or a lingual wall, respectively, of the buccal or lingual cutting guide and located proximal to the buccal or the lingual slot, respectively.

11. A system in accordance with claim 1, wherein the at least one the cutting guide further comprises a window formed in a buccal or a lingual wall of the cutting guide and extending from the exterior of the cutting guide to the at least one cavity, and being wider than the slot.

12. A system in accordance with claim 1, wherein the at least one the cutting guide further comprises an enlarged opening to allow insertion of the sleeve or the enlarged collar thereof.

13. A method for cutting a patient's tooth utilizing the system in accordance with claim 1, the method comprising:
a) placing the cutting guide on the least one of the patient's teeth with the cavity of the cutting guide matching at least a portion of at least one of the patient's teeth;
b) inserting the sleeve into the slot of the cutting guide and the enlarged collar of the sleeve into the opposing channels in the opposing walls of the slot;
c) inserting the bur of the cutting tool into the sleeve with the bur passing through the sleeve and the shank of the cutting tool rotatable in the sleeve;
d) displacing the cutting tool along the slot with the sleeve slidable in the slot to cut a portion of the patient's tooth with the bur; and
e) selectively retracting and inserting the cutting tool in the sleeve.

14. The method in accordance with claim 13, further comprising, under the control of one or more computer systems configured with executable instructions:
a) obtaining a 3D image of the patient's teeth;
b) digitally preparing a tooth to be cut based on the 3D image;
c) digitally designing a restoration;
d) digitally designing the cutting guide; and
e) producing the cutting guide and the restoration.

15. A dental cutting system for cutting a patient's tooth, the system comprising at least one cutting guide with at least one slot therein, and a cutting tool guided by the slot, and further comprising:
a) opposing channels formed in opposing walls of the slot and extending along a length of the slot;
b) a sleeve slidably disposed in the slot and slidable along the slot;
c) the sleeve having an enlarged collar slidably disposed in the opposing channels and retaining the sleeve in the slot with respect to an in-and-out direction with respect to the at least one cavity of the cutting guide and limiting the sleeve to movement within and along the slot; and
d) the sleeve having a bore extending axially therethrough and removably receiving the cutting tool therein, the cutting tool being rotatable therein and slidable therethrough in the in-and-out direction and into and out of the sleeve such that the cutting tool has two transverse degrees of freedom, including laterally along the slot, and in and out of the slot and the sleeve.

16. A dental cutting system for cutting a patient's tooth, the system comprising:
a) a plurality of cutting guides each having at least one cavity to match at least a portion of at least one of a patient's teeth, and each having a slot in the cutting guide with a depth extending from an exterior of the cutting guide to the at least one cavity;
b) each of the plurality of cutting guides comprising a main body configured to engage at least one of a patient's teeth including buccal, lingual and occlusal walls, and each of the at least one cutting guides comprising a protrusion extending from the main body and having the slot therein, with the protrusion having a wall surrounding a majority of the slot with a constant cross-sectional shape;
c) the plurality of cutting guides comprising:
1) a buccal cutting guide with a buccal slot located on the cutting guide; and
2) a lingual cutting guide with a lingual slot located on the cutting guide;
d) a cutting tool having a shank and a cutting bur configured to cut the patient's tooth;
e) a pair of opposing channels formed in opposing walls of the slot and extending along a length of the slot in each of the plurality of cutting guides;
f) at least one sleeve slidably disposed in at least one of the slots and slidable along the at least one of the slots;
g) the at least one sleeve having a pair of enlarged collars slidably disposed in the pair of opposing channels and retaining the at least one sleeve in the at least one slot with respect to an in-and-out direction with respect to the at least one cavity of a respective cutting guide and limiting the at least one sleeve to movement within and along the at least one slot;
h) the pair of enlarged collars having a cross-sectional shape that matches a cross-sectional shape of the pair of opposing channels;
i) the at least one sleeve having a bore extending axially therethrough and removably receiving the cutting tool therein, the shank of the cutting tool being rotatable therein and the bur of the cutting tool being slidable therethrough in the in-and-out direction and into and out of the at least one sleeve such that the cutting tool can rotate to cut, slide laterally in the slot along with the at least one sleeve, and displace in the in-and-out direction with respect to the at least one cavity of the respective cutting guide, and into and out of the at least one sleeve; and
j) the cutting tool having two transverse degrees of freedom, including laterally along the slot, and in and out of the slot and the at least one sleeve.

17. A system in accordance with claim 16, wherein the plurality of cutting guides further comprises:
an occlusal cutting guide with an occlusal slots located laterally on the occlusal cutting guide.

18. A system in accordance with claim 16, wherein the buccal and lingual cutting guides further comprise an occlusal slot.

19. A system in accordance with claim 16, further comprising:
a) a buccal window disposed in the buccal wall of the at buccal cutting guide and located proximal to the buccal slot; and
b) a lingual window disposed in the lingual wall of the at lingual cutting guide and located proximal to the lingual slot.

20. A method for cutting a patient's tooth, comprising:
a) placing a cutting guide on at least one of the patient's teeth with a cavity of the cutting guide matching at least a portion of at least one of the patient's teeth;
b) inserting a sleeve into a slot of the cutting guide and an enlarged collar of the sleeve into opposing channels in opposing walls of the slot;
c) inserting a bur of a cutting tool into the sleeve with the bur passing through the sleeve and a shank of the cutting tool rotatable in the sleeve;
d) displacing the cutting tool along the slot with the sleeve slidable in the slot to cut a portion of the patient's tooth with the bur; and
e) selectively retracting and inserting the cutting tool in the sleeve.

21. A method in accordance with claim 20, further comprising:
withdrawing the cutting tool from the sleeve and the cutting guide while the sleeve remains in the slot of the cutting guide.
